(19) United States
(12) Patent Application Publication
(10) Pub. No.: US 2026/0065604 A1
(43) Pub. Date: Mar. 5, 2026

(54) INFORMATION PROCESSING APPARATUS, INFORMATION PROCESSING SYSTEM, INFORMATION PROCESSING METHOD, AND MEDIUM

(71) Applicant: CANON KABUSHIKI KAISHA, Tokyo (JP)

(72) Inventors: MAMORU TANAE, Saitama (JP); AZUSA MATSUMOTO, Kanagawa (JP); HIDEKAZU KAMEI, Kanagawa (JP); YUSUKE OKABE, Tokyo (JP)

(21) Appl. No.: 19/313,696

(22) Filed: Aug. 28, 2025

(30) Foreign Application Priority Data
Sep. 4, 2024 (JP) 2024-152411

(51) Int. Cl. G06T 19/00; G06T 19/20

(52) U.S. Cl. CPC G06T 19/006; G06T 19/20; G06T 2219/2004; G06T 2219/2016

(57) ABSTRACT

An information processing apparatus is provided. The apparatus detects, from a medium, identification information for identifying 3D model data representing 3D models of an object respectively corresponding to a plurality of timecodes. The apparatus accepts a user operation to designate a timecode of a display target. The apparatus causes a display to display an image of the object based on a 3D model of the object corresponding to the timecode in accordance with the identification information and the user operation. The apparatus records, in accordance with a user operation, a virtual image to be synthesized with a captured image. The virtual image includes the image of the object displayed on the display.

### BACKGROUND

### Field of the Technology

The present disclosure relates to an information processing apparatus, an information processing system, an information processing method, and a medium, in particular to an AR technology.

### Description of the Related Art

A technology of controlling the position and shape of a virtual object is known. For example, Japanese Patent Laid-Open No. 2020-166741 discloses arranging a virtual object at a position where a mark exists in a captured image. Japanese Patent Laid-Open No. 2020-166741 also discloses performing projective transformation on a virtual object that is a 3D image based on the shape of an image of a mark on a captured image.

An image of a virtual object can be synthesized with a captured image. Such an image of the virtual object is called an AR frame. For example, the user can select an AR frame on a terminal and synthesize the selected AR frame with a desired captured image.

According to the technology described in Japanese Patent Laid-Open No. 2020-166741, the position and shape of the virtual object are automatically determined. On the other hand, the user may desire to select an object to be synthesized with a captured image in accordance with his/her wish.

### SUMMARY

The technology according to the present disclosure can make it easy for a user to select an image of an object to be synthesized with a captured image from among variations.

According to an embodiment, an information processing apparatus comprises one or more memories storing instructions and one or more processors that execute the instructions to: detect, from a medium, identification information for identifying 3D model data representing 3D models of an object respectively corresponding to a plurality of timecodes; accept a user operation to designate a timecode of a display target; cause a display to display an image of the object based on a 3D model of the object corresponding to the timecode in accordance with the identification information and the user operation; and record, in accordance with a user operation, a virtual image to be synthesized with a captured image, the virtual image including the image of the object displayed on the display.

According to another embodiment, an information processing system comprises one or more memories storing instructions and one or more processors that execute the instructions to: detect, from a medium, identification information for identifying 3D model data representing 3D models of an object respectively corresponding to a plurality of timecodes; accept a user operation to designate a timecode of a display target; generate an image of the object based on a 3D model of the object corresponding to the timecode in accordance with the identification information and the user operation; cause a display to display the image of the object; and record, in accordance with a user operation, a virtual image to be synthesized with a captured image, the virtual image including the image of the object displayed on the display.

According to still another embodiment, an information processing method comprises: detecting, from a medium, identification information for identifying 3D model data representing 3D models of an object respectively corresponding to a plurality of timecodes; accepting a user operation to designate a timecode of a display target; causing a display to display an image of the object based on a 3D model of the object corresponding to the timecode in accordance with the identification information and the user operation; and recording, in accordance with a user operation, a virtual image to be synthesized with a captured image, the virtual image including the image of the object displayed on the display.

According to yet another embodiment, a non-transitory computer-readable medium stores a program executable by a computer to perform a method comprising: detecting, from a medium, identification information for identifying 3D model data representing 3D models of an object respectively corresponding to a plurality of timecodes; accepting a user operation to designate a timecode of a display target; causing a display to display an image of the object based on a 3D model of the object corresponding to the timecode in accordance with the identification information and the user operation; and recording, in accordance with a user operation, a virtual image to be synthesized with a captured image, the virtual image including the image of the object displayed on the display.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating a configuration example of an information processing system according to one or more aspects of the present disclosure.

FIG. 2 is a view illustrating a hardware configuration example of an information processing apparatus according to one or more aspects of the present disclosure.

FIG. 3 is a view illustrating a functional configuration example of the information processing apparatus according to one or more aspects of the present disclosure.

FIGS. 4A and 4B are views illustrating an example of a user interface.

FIG. 5 is a view showing a flowchart of an information processing method according to one or more aspects of the present disclosure.

FIG. 6 is a view illustrating an example of the user interface.

FIG. 7 is a view showing a flowchart of the information processing method according to one or more aspects of the present disclosure.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### System Configuration

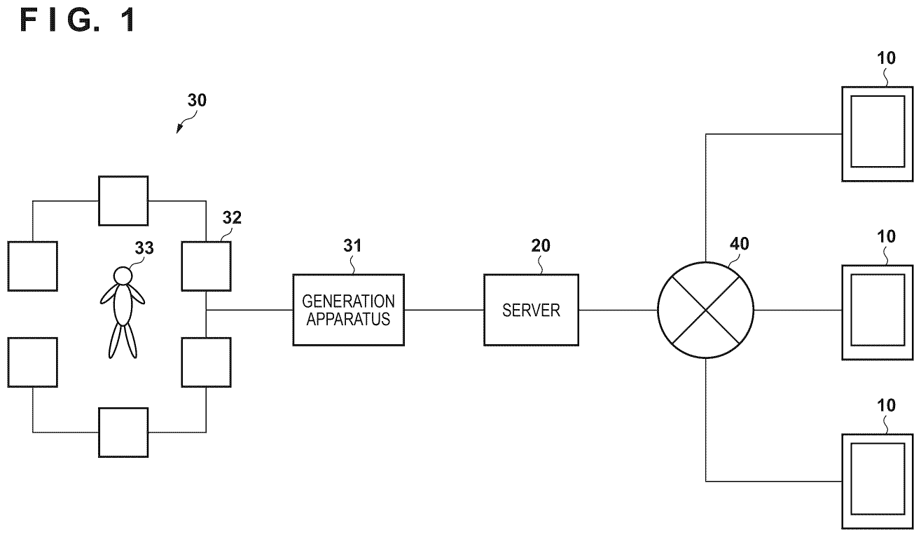

An information processing system according to one embodiment will be described with reference to FIG. 1. FIG. 1 illustrates a configuration example of the information processing system according to one embodiment. The information processing system includes a terminal 10 and a server 20.

The terminal 10 is an information processing apparatus operated by a user to display an image of an object. The server 20 is an information processing apparatus that generates an image of an object. In the present embodiment, the server 20 stores 3D model data of an object to be used to generate an image of the object.

The 3D model can represent a three-dimensional shape of an object. The 3D model can represent a color at each position of the three-dimensional shape of the object. In this manner, the 3D model can represent the appearance of the object.

In the present embodiment, the 3D model data includes 3D models of objects respectively corresponding to a plurality of timecodes. Such 3D model data can represent the three-dimensional shape of the object that changes with time. The timecode is information indicating a time associated with the 3D model of the object.

The types of the object and the 3D model data are not particularly limited. In one embodiment, the 3D model data is 3D model data of a subject generated using a volumetric capture technology. Such the 3D model data of the subject can be generated using captured images of the subject from a plurality of viewpoints. In this case, the object can represent a real subject.

FIG. 1 illustrates a configuration example of a capturing system 30 that generates 3D model data of the subject. The capturing system 30 includes a generation apparatus 31 and a plurality of capturing apparatuses 32. The plurality of capturing apparatuses 32 are a plurality of cameras installed so as to capture the subject 33 from respectively different directions. The plurality of capturing apparatuses 32 can perform capturing a plurality of times in synchronization in a capturing period. Thus, the plurality of capturing apparatuses 32 can generate a captured image group of the subject 33 from respectively different viewpoints at a plurality of times. In the capturing period, the position and shape of the subject 33 can change.

The generation apparatus 31 generates 3D model data of the subject 33 using the captured images obtained by the plurality of capturing apparatuses 32. A generation method of the 3D model data is not particularly limited. The generation apparatus 31 can generate 3D model data of the subject 33 based on, for example, a volume intersection method or a photo hull technique. As a specific example, the generation apparatus 31 can extract a subject 33 region from each of the captured image group of the subject 33 from respectively different viewpoints obtained by synchronous capturing at a certain time. In order to extract the subject 33 region, for example, a background differencing technique can be used. Then, the generation apparatus 31 can estimate the three-dimensional shape of the subject 33 based on the extraction result of the subject 33 region and respective camera parameters of the plurality of capturing apparatuses 32. Furthermore, the generation apparatus 31 can generate a texture to be given to the 3D model of the subject 33 based on the captured image group of the subject 33. In this manner, the generation apparatus 31 can generate the 3D model of the subject 33 at a certain time. By performing such processing using the captured image group respectively at a plurality of times, the generation apparatus 31 can generate the 3D model of the subject 33 respectively at the plurality of times. In this case, the timecode corresponds to the capturing time.

On the other hand, the object may be a virtual object. For example, the object may represent an animation character or a virtual idol. The 3D model data of such an object can be generated using a 3DCG creation apparatus.

The terminal 10 is connected to the server 20 via a network 40. As illustrated in FIG. 1, a plurality of the terminals 10 can be connected to the server 20. The type of the network 40 is not particularly limited. The network 40 can be, for example, the Internet or an intranet. The network 40 can be a wireless network or a wired network.

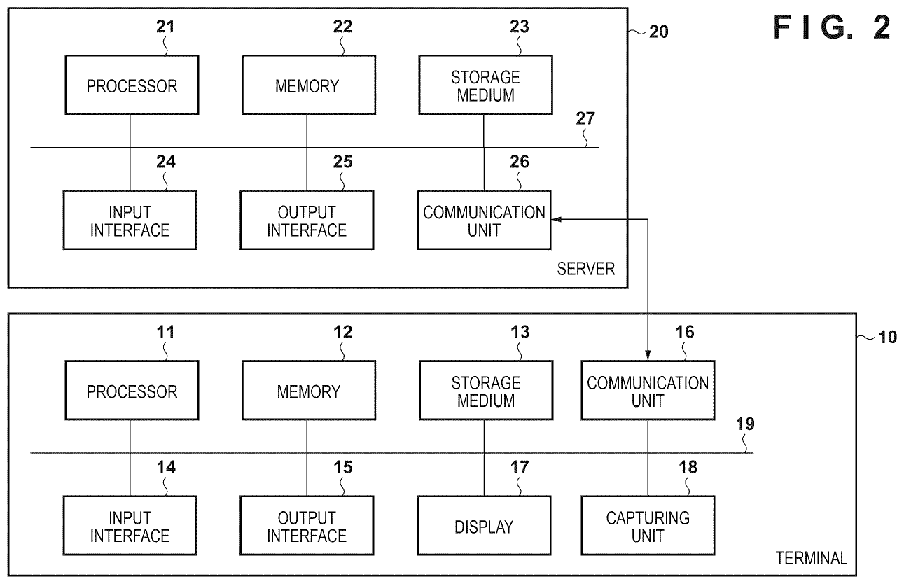

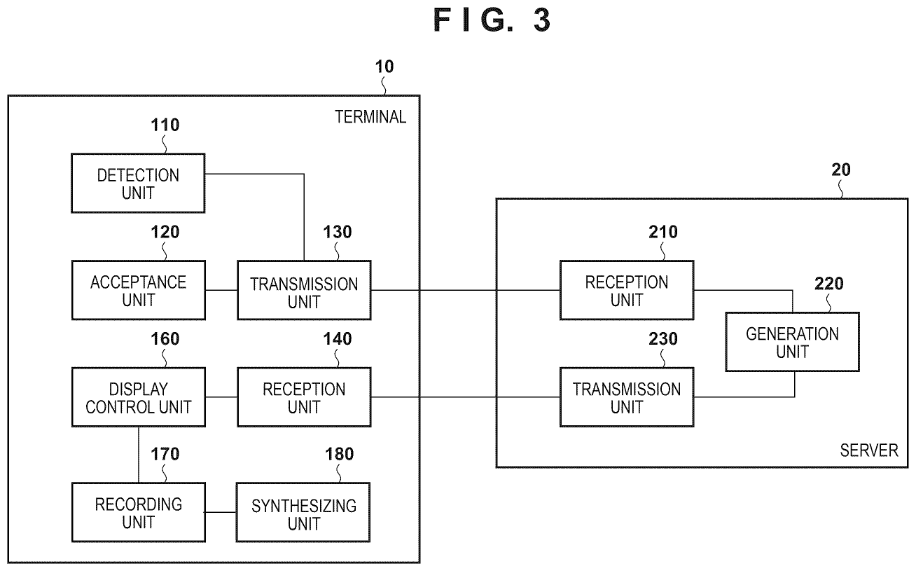

Next, hardware configuration examples of the terminal 10, which is an information processing apparatus according to one embodiment, and the server 20, which is an information processing apparatus according to one embodiment, will be described with reference to FIG. 2. The terminal 10 and the server 20 can be implemented using a computer. Examples of the computer include a general-purpose desktop computer, a laptop computer, a tablet PC, or a smartphone. Note that FIGS. 2 and 3 merely illustrate examples of the information processing apparatus. For example, the information processing apparatus according to one embodiment may include a plurality of information processing apparatuses connected via a network.

As illustrated in FIG. 2, the terminal 10 includes a processor 11, a memory 12, a storage medium 13, an input interface 14, an output interface 15, a communication unit 16, a display 17, a capturing unit 18, and a bus 19. The processor 11 is, for example, a CPU, and controls the operation of the entire computer. The memory 12 is, for example, a RAM, and temporarily stores programs, data, and the like. The storage medium 13 that is computer-readable is, for example, a hard disk, a CD-ROM, or the like, and stores programs, data, and the like for a long period of time. In the present embodiment, a program that is stored in the storage medium 13 and implements the function of each unit illustrated in FIG. 3 is read into the memory 12. Then, the processor 11 operates in accordance with the program on the memory 12, thereby implementing the function of each unit.

The input interface 14 is an interface for acquiring information. For example, the input interface 14 may be connected to an input apparatus that accepts an operation by the user, such as a keyboard, a mouse, or a joystick. The output interface 15 is an interface for outputting information. For example, the output interface 15 may be connected to an output apparatus such as an external display. The communication unit 16 is an interface for connecting to a network. The display 17 is a screen that can display information. The display 17 can display a graphical user interface (GUI) for the user to operate the system. The display 17 is, for example, a liquid crystal display, a touch panel, or the like. The capturing unit 18 performs capturing to generate a captured image. The capturing unit 18 is, for example, a camera. The bus 19 connects each unit described above and enables data exchange.

The server 20 includes a processor 21, a memory 22, a storage medium 23, an input interface 24, an output interface 25, a communication unit 26, and a bus 27. The function of each unit is similar to that of the terminal 10.

Next, a functional configuration example of the terminal 10 will be described with reference to FIG. 3. The terminal 10 includes a detection unit 110, an acceptance unit 120, a transmission unit 130, a reception unit 140, a display control unit 160, a recording unit 170, and a synthesizing unit 180.

The detection unit 110 acquires identification information for identifying 3D model data. In the present embodiment, the identification information is attached to the medium. The medium has a function of transmitting identification information, and the type thereof is not particularly limited. For example, the medium may be a planar object such as paper or a three-dimensional object. Examples of the medium include printed matters such as a business card, a letter, an advertisement, and a booklet. Other examples of the medium include a shaped object of a character. Examples of the shaped object of a character include a resin plate on which a character is printed (e.g., an acrylic stand), a character figure, and a stuffed toy.

The identification information can be information for uniquely specifying the 3D model data. For example, the identification information may be a uniform resource identifier (URI). The identification information may be a file name of specific 3D model data stored in the server 20. Note that the identification information may indicate the location of 3D model data stored in an apparatus different from the server 20. As described later, a generation unit 220 of the server 20 can acquire 3D model data corresponding to the identification information. On the other hand, the identification information may be an identifier such as an ID of the 3D model data. In this case, the server 20 can acquire the 3D model data corresponding to the identification information with reference to a database. Such a database can manage information indicating the location of the 3D model data in association with the identification information.

In one embodiment, the detection unit 110 detects the identification information based on an image of a medium. The image of the medium can be a captured image of the medium obtained using the capturing unit 18, for example. In such an embodiment, the identification information may be printed as a code on the medium. Specific examples of the code include a barcode and a QR code (registered trademark) that encode identification information.

On the other hand, the detection unit 110 may detect the identification information by image recognition processing on the image of the medium. The image recognition processing can be, for example, image identification processing of recognizing the type of the subject. For example, in a case where a picture of a character is printed on a medium, the detection unit 110 can specify the character by image recognition processing. The detection unit 110 can determine a specific variation printed on the medium among a plurality of variations of the picture of the character by the image recognition processing. The detection unit 110 can perform such image recognition processing using, for example, a trained neural network. In such an example, the identification information can be an ID representing the type of the subject. In this case, the server 20 can acquire the 3D model data corresponding to the ID with reference to the database.

The identification information may be a feature amount (e.g., a feature vector) of the subject. The detection unit 110 can detect such identification information by feature amount extraction processing on the image of the medium. Furthermore, the identification information may be an image of the medium itself. The server 20 can recognize the type of the subject by performing image recognition processing or identification processing using these pieces of identification information. The server 20 can acquire the 3D model data corresponding to the recognized subject with reference to the database. Therefore, such the identification information can also be used as information for identifying the 3D model data. In this manner, detecting an identification result from a medium may include capturing an image.

In another embodiment, the detection unit 110 detects identification information based on the information transmitted by the medium. For example, the medium may include an information transmission circuit such as an RFID. In this case, the detection unit 110 can acquire the identification information transmitted from the information transmission circuit included in the medium via the communication unit 16.

The acceptance unit 120 accepts a user operation to designate a timecode of a display target. As described above, the 3D model data can represent the three-dimensional shape of the object that changes with time. In the present embodiment, the three-dimensional shape of the object corresponding to a specific timecode is displayed on the display 17 based on the user operation. In this manner, in the present embodiment, the user can select a desired object from among objects that change with time.

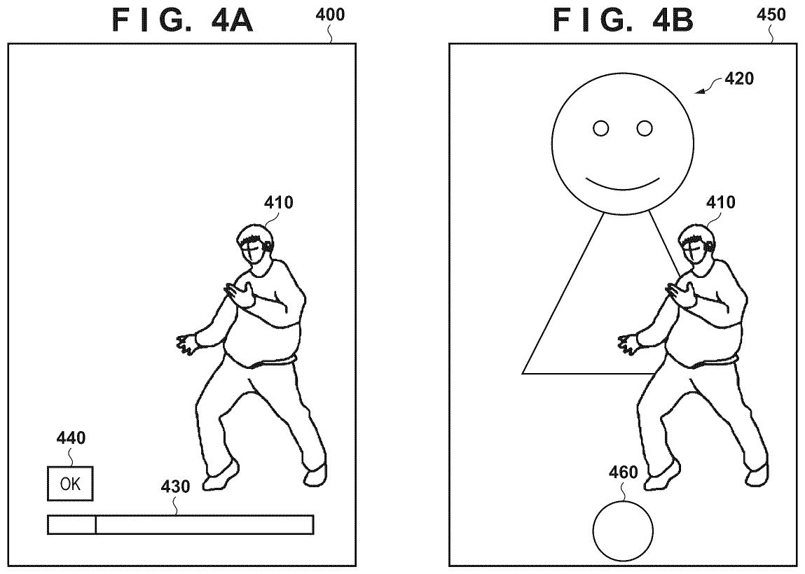

The acceptance unit 120 can accept a user operation to designate at least one of the position of the object, the orientation of the object, and the size of the object. For example, the acceptance unit 120 may accept a user operation to designate the orientation of the object. The user operation to designate the orientation of the object may be a user operation to designate a viewpoint with respect to the 3D model of the object. The acceptance unit 120 may accept a user operation to designate the position of the object. The acceptance unit 120 may accept a user operation to designate the size of the object. The user can change a display mode of the object on the image by these user operations. Processing of accepting the user operation will be described later with reference to FIGS. 4A and 4B.

The type of the user operation and the acquisition method of the user operation are not particularly limited. For example, the acceptance unit 120 can accept various user operations via the input interface 14. In the present embodiment, the display 17 is a touch panel, and the acceptance unit 120 can accept a user operation on a touch sensitive display.

The transmission unit 130 transmits, to the server 20 via the communication unit 16, the identification information and the timecode accepted by the acceptance unit 120. The transmission unit 130 may transmit, to the server 20, information to be used when other objects are rendered. Such information can include information indicating the display mode of the object in accordance with the user operation, such as information designating the viewpoint with respect to the 3D model of the object.

The reception unit 140 receives the image of the object transmitted from the server 20 via the communication unit 16. As described later, the image of the object is generated by the server 20 in accordance with the identification information and the timecode transmitted to the server 20. That is, the image of the object received by the reception unit 140 is an image of the object based on the 3D model data of the object corresponding to the timecode in accordance with the identification information and the user operation.

The display control unit 160 causes the display 17 to display the image of the object. For example, the display control unit 160 can cause the display 17 to display the image of the object received by the reception unit 140.

Furthermore, the display control unit 160 can cause the display 17 to display a user interface for designating at least one of the timecode, the position of the object, the orientation of the object, and the size of the object. For example, the display control unit 160 can cause the display 17 to display the user interface for designating the timecode. FIG. 4A illustrates an example of such a user interface. A screen 400 displayed on the display 17 includes an object 410, a timebar 430, and a button 440.

The object 410 is an image of an object generated by the server 20 and received by the reception unit 140. The object 410 is generated in accordance with the user operation accepted by the acceptance unit 120. For example, the user can designate one timecode from among a plurality of timecodes by operating the timebar 430. The user may designate the timecode by a touch operation or a slide operation on the timebar 430. When the user changes the timecode of the display target by the operation of the timebar 430, the transmission unit 130 transmits, to the server 20, the identification information and a changed timecode. The reception unit 140 acquires an image of an object corresponding to the changed timecode. Then, the display control unit 160 updates the object 410 displayed on the screen 400 with the image of the object acquired by the reception unit 140. In this manner, the user can determine a desired timecode while viewing the object corresponding to the designated timecode.

The user can perform another operation of changing the display mode of the object on the user interface displayed on the display 17. For example, as described above, the acceptance unit 120 can accept a user operation to designate the orientation of the object. The acceptance unit 120 can accept a user operation to designate the viewpoint with respect to the object. For example, the user can perform a flick operation or a rotation operation on the object 410 in order to rotate the object. Rotating the object corresponds to changing the viewpoint with respect to the 3D model used when the object is rendered. In this case, as described above, the transmission unit 130 can transmit, to the server 20, information designating the viewpoint with respect to the 3D model of the object in accordance with the user operation. Then, the server 20 can generate an image from a designated start point of the object corresponding to the designated timecode. Also in this case, the display control unit 160 can update the object 410 displayed on the screen 400 with the image of the object generated and transmitted by the server 20. In this manner, the display control unit 160 can cause the display 17 to display the image of the object from the designated viewpoint.

The user can perform an operation of designating the position of the object. For example, the user can perform a drag operation (or a drag operation after long pressing) from the object 410 in order to translate the object. In this case, the display control unit 160 can display the image of the object generated and transmitted by the server 20 at a position in accordance with the user operation on the screen 400. Note that the transmission unit 130 may transmit, to the server 20, information designating the position of the object. In this case, the server 20 can render the 3D model so that the object is displayed at the designated position.

The user can perform an operation of designating the size of the object. For example, the user can perform a pinch out operation or a pinch in operation on the object 410 to enlarge or reduce the object. In this case, the display control unit 160 can perform enlargement or reduction processing in accordance with the user operation on the image of the object generated and transmitted by the server 20. Then, the display control unit 160 can display the enlarged or reduced image of the object on the screen 400. Note that the transmission unit 130 may transmit information designating the size of the object to the server 20. For example, the transmission unit 130 may transmit information for designating the viewpoint so that the distance from the object 3D model to the viewpoint is short or long. In this case, the server 20 can render the 3D model so that the object is displayed with a designated size.

When judging that the image of the desired object is displayed on the screen 400 as a result of the user operation, the user can press the button 440. At this time, as described below, the recording unit 170 can record the image of the object.

The recording unit 170 records a virtual image to be synthesized with the captured image, including the image of the object displayed on the display 17, in accordance with the user operation. The data format of the virtual image is not particularly limited. The recording unit 170 can record the virtual image in a memory in the terminal 10 such as the storage medium 13, for example. The recording unit 170 may record the virtual image in an apparatus other than the terminal 10 such as the server 20.

In one embodiment, the recording unit 170 records, as a virtual image, the image of the object generated by the server 20 and received by the reception unit 140. On the other hand, as described above, the display control unit 160 can perform processing of changing the display mode such as the position or size of the object. In this case, the recording unit 170 can generate and record the virtual image including an image of the object whose display mode has been changed in accordance with a user operation.

The synthesizing unit 180 generates a synthesized image of the virtual image recorded by the recording unit 170 and the captured image. The synthesizing unit 180 can generate a synthesized image of a virtual image selected by the user from among the plurality of virtual images recorded by the recording unit 170 and the captured image. For this reason, the display control unit 160 can display a list of one or more virtual images on the display 17. For example, the display control unit 160 can display, on the display 17, thumbnails of respective virtual images recorded by the recording unit 170. The acceptance unit 120 can accept a user operation to select the virtual image from among the virtual images displayed in the list.

In the present embodiment, the captured image is an image captured by the capturing unit 18 in real time. The synthesizing unit 180 may synthesize the respective captured images sequentially obtained by the capturing unit 18 with a common virtual image. In this case, the synthesizing unit 180 can sequentially generate, in real time, synthesized images of the captured image by the capturing unit 18 and the virtual image. On the other hand, the captured image may be a captured image stored in the terminal 10.

The synthesizing unit 180 can further record a synthesized image. The synthesizing unit 180 can record the synthesized image in the memory in the terminal 10 such as the storage medium 13, for example. The synthesizing unit 180 may record the synthesized image in an apparatus other than the terminal 10 such as the server 20. The synthesizing unit 180 may record the synthesized image in accordance with a user instruction. For example, the synthesizing unit 180 may record only the synthesized image selected by the user among the plurality of synthesized images. When the synthesizing unit 180 sequentially generates synthesized images of the captured image and the virtual image, the synthesizing unit 180 can record the latest synthesized image at the timing designated by the user. For example, the acceptance unit 120 can accept a user operation to record the synthesized image. The user operation to record the synthesized image may be an operation of pressing the button 460 illustrated in FIG. 4B. The button 460 corresponds to a shutter button.

In one embodiment, the virtual image has a foreground region, which is a region of the image of the object, and a transmissive region. When such the virtual image and the captured image are synthesized, the image of the object is superimposed on the captured image in the foreground region, and the captured image is maintained in the transmissive region. That is, in the synthesized image, the image of the object is presented in a region corresponding to the foreground region, and the captured image is presented in a region corresponding to the transmissive region. FIG. 4B illustrates an example of a screen 450 illustrating the thus generated synthesized image. On the screen 450, the object 410 and a captured image 420 are presented.

Here, the recording unit 170 can record information indicating the region of the image of the object in the virtual image. For example, the data of the virtual image to be recorded by the recording unit 170 may include the pixel value of each pixel of the foreground region indicating color information of the image of the object and the pixel value of each pixel of the transmissive region indicating color information corresponding to a transparent color. In another embodiment, the recording unit 170 may record metadata indicating the region of the image of the object in the virtual image in association with the virtual image.

In one embodiment, the virtual image has the same aspect ratio as that of the captured image by the capturing unit 18 so as to facilitate synthesis of the virtual image and the captured image. On the other hand, the virtual image may be represented by image data including shape information indicating the two-dimensional shape of the object, position information indicating the two-dimensional position of the object, and color information of the object at each pixel.

Next, a functional configuration example of the server 20 will be described with reference to FIG. 3. The server 20 includes a reception unit 210, the generation unit 220, and a transmission unit 230.

The reception unit 210 receives the identification information and the timecode transmitted from the terminal 10 as described above via the communication unit 26. As described above, the reception unit 210 can also receive information for designating a viewpoint with respect to the object or information used when another object is rendered.

The generation unit 220 generates an image of the object based on the 3D model data of the object corresponding to the identification information transmitted from the terminal. As described above, the generation unit 220 can acquire the 3D model data in accordance with the identification information. The generation unit 220 can specify the 3D model of the object of the display target in accordance with the designated timecode. Then, the generation unit 220 can render an image (virtual viewpoint image) of the 3D model of the object of the display target from the viewpoint designated using the terminal 10 or from a prescribed viewpoint. A rendering method is not particularly limited, and for example, a ray tracing method can be used.

The format of the image of the object to be generated by the generation unit 220 is not particularly limited. For example, the generation unit 220 may generate image data including the foreground region, which is a region of the image of the object, and the transmissive region. Here, the foreground region may correspond to a region where the 3D model of the object appears. The transmissive region may correspond to a region where the 3D model of the object does not appear. The generation unit 220 may generate image data including shape information indicating the two-dimensional shape of the rendered object and color information of the object at each pixel. The image data may include position information indicating the position of the object on the screen.

The image of the object to be generated by the generation unit 220 may have a background. For example, the generation unit 220 may generate the image of the object by rendering the 3D model of the object corresponding to the designated timecode and further synthesizing the background with the rendering result. The background may be common for the plurality of timecodes. Such background data may be included in the 3D model data. In this case, the generation unit 220 may generate image data including the foreground region, which is a region of the image of the object and a region of the background, and the transmissive region.

The transmission unit 230 transmits the image of the object generated by the generation unit 220 to the terminal 10 via the communication unit 26.

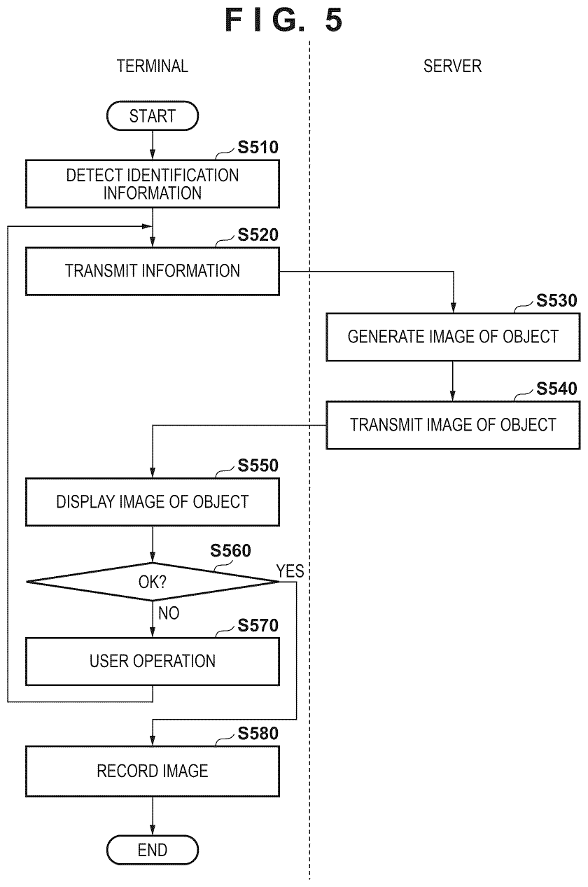

Next, an information processing method according to one embodiment will be described with reference to the flowchart of FIG. 5 showing the operations of the terminal 10 and the server 20 according to one embodiment. A virtual image is recorded in accordance with the user operation by the operation shown below.

In S510, the detection unit 110 acquires the identification information as described above. In S520, the acceptance unit 120 transmits the identification information and the timecode to the server 20. At this time, the acceptance unit 120 may transmit information for designating the viewpoint of the 3D model to the server 20. Note that in the first S520, the acceptance unit 120 can transmit a default timecode and/or information for designating a default viewpoint to the server 20. The default timecode may be a timecode corresponding to the start time, for example. The default viewpoint may be set to face the 3D model at a position in front of the 3D model, for example, and away from the 3D model by a predetermined distance.

In S530, the generation unit 220 generates the image of the 3D model of the object as described above in accordance with the identification information and the timecode transmitted from the terminal 10 and received by the reception unit 210. In S540, the transmission unit 230 transmits, to the terminal 10, the image of the object generated by the generation unit in S530.

In S550, the display control unit 160 causes the display 17 to display the image of the object transmitted from the server 20 and received by the reception unit 140. In S560, the display control unit 160 determines whether or not the user operation has ended. For example, when the button 440 is pressed, the display control unit 160 can determine that the user operation has ended. When it is determined that the user operation has ended, the processing proceeds to S580. Otherwise, the processing proceeds to S570.

In S570, the acceptance unit 120 accepts the user operation as described above. For example, the acceptance unit 120 can accept a user operation to designate the timecode, a user operation to designate the viewpoint, or the like. Thereafter, the processing returns to S520. In S520, the information used when the timecode, viewpoint, or other object designated in S570 are rendered is transmitted to the terminal 10.

In S580, the recording unit 170 records the virtual image to be synthesized with the captured image as described above.

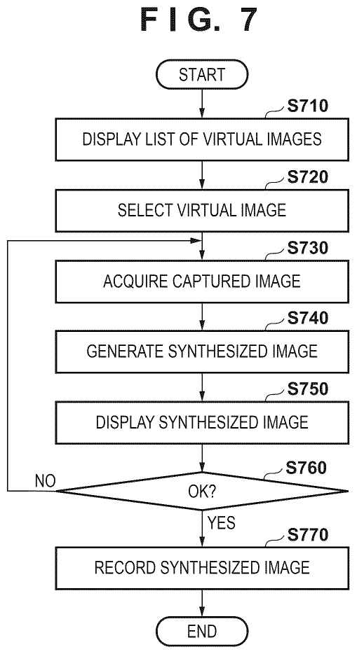

Next, the information processing method according to one embodiment will be described with reference to the flowchart of FIG. 7 showing the operation of the terminal 10 according to one embodiment. The synthesized image of the virtual image and the captured image is generated by the operation shown below.

In S710, the display control unit 160 displays, on the display 17, a list of the virtual images recorded by the recording unit 170 as described above. In S720, the synthesizing unit 180 selects the virtual image to be synthesized with the captured image from the virtual images recorded by the recording unit 170. The synthesizing unit 180 can select the virtual image in accordance with the user operation accepted by the acceptance unit 120 as described above.

In S730, the synthesizing unit 180 acquires the captured image obtained by the capturing unit 18. The synthesizing unit 180 can acquire the captured image obtained by the capturing unit 18 in real time. In S740, the synthesizing unit 180 generates the synthesized image by synthesizing, as described above, the virtual image selected in S720 and the captured image acquired in S730. In S750, the display control unit 160 displays the synthesized image generated in S740 on the display 17. For example, the display control unit 160 can cause the display 17 to display the screen 450 illustrated in FIG. 4B.

In S760, the synthesizing unit 180 determines whether or not the user operation to record the synthesized image has been performed as described above. When it is determined that the user operation to record the synthesized image has been performed, the processing proceeds to S770. Otherwise, the processing returns to S730, and the synthesized image of another captured image and the virtual image is generated. In S770, the synthesizing unit 180 records the synthesized image generated in S740.

As described above, according to the present embodiment, the identification information detected from the medium is associated with the 3D model data of the object respectively corresponding to the plurality of timecodes. The user of the terminal 10 can select the desired object while checking, on the display, the image of the object corresponding to the designated timecode. Therefore, the user can easily select the image of the object from among more variations.

As described above, the terminal 10 displays the object corresponding to the identification information detected from the medium, and records the virtual image including the object. According to such the configuration, since the owner of the medium can generate a synthesized image including the object associated with the medium, the value of the medium can be improved. The terminal 10 can automatically display the image of the object corresponding to the medium based on the detection result of the identification information. Therefore, according to the present embodiment, it is possible to reduce the operation burden on the user for generating the synthesized image.

### Modification

In the above-described embodiment, the user can designate the position of the object to be displayed. On the other hand, the display control unit 160 may display the object at the position of the medium in the captured image. For example, the detection unit 110 can detect the medium (or the code attached to the medium) from the captured image by the image recognition processing. The synthesizing unit 180 can generate a synthesized image of the captured image and the image of the object so that the image of the object is superimposed at the position corresponding to the position of the medium detected from the captured image. Then, the display control unit 160 can cause the display 17 to display the synthesized image generated by the synthesizing unit 180. According to such the configuration, it is possible to display an object related to the medium in the vicinity of the medium. For example, it is possible to display an image of an object of a person described in a business card in the vicinity of the business card on which a code is printed. It is possible to display an image of an object indicating a character so as to be superimposed on an acrylic stand on which this character is printed.

The designation method of the orientation or size of the object to be displayed on the display 17 or the viewpoint with respect to the 3D model of the object is not limited to the above method. For example, the user operation to designate the viewpoint may include an operation of changing the physical position and attitude of the terminal 10. For example, the viewpoint with respect to the 3D model of the object may be a viewpoint in accordance with the position and attitude of the terminal 10.

In one embodiment, the viewpoint with respect to the object is indicated by the physical position and attitude of the information processing apparatus with respect to the medium. For example, when displaying an image from above the 3D model of the object, the user can move the terminal 10 above the medium and control the attitude of the terminal 10 so that the optical axis of the capturing unit 18 faces the medium. According to such an embodiment, the user can set the viewpoint with respect to the object by an intuitive operation. Note that the position and attitude of the terminal 10 with respect to the medium can be determined based on the image of the medium or the code in the captured image obtained by the capturing unit 18, for example.

In the above-described embodiment, an image of one object is displayed on the display 17. However, images of a plurality of objects may be displayed on the display 17. In such an embodiment, the identification information can identify the 3D model data of the plurality of objects, respectively. For example, a plurality of codes may be printed on the medium. Then, the plurality of codes may respectively indicate the location of the 3D model data of the object. As another method, the database referred to by the server 20 may indicate the location of the 3D model data of the plurality of objects, respectively, corresponding to the identification information.

In this case, the acceptance unit 120 can accept a user operation to designate the timecode of the display target independently for the plurality of objects, respectively. The generation unit 220 can generate the respective images of the plurality of objects based on the 3D model data of the object corresponding to the respective timecodes in accordance with a user operation. Then, the display control unit 160 can cause the display 17 to display the respective images of the plurality of objects generated by the generation unit 220 in this manner. The recording unit 170 can record a virtual image including images of the plurality of objects displayed on the display 17.

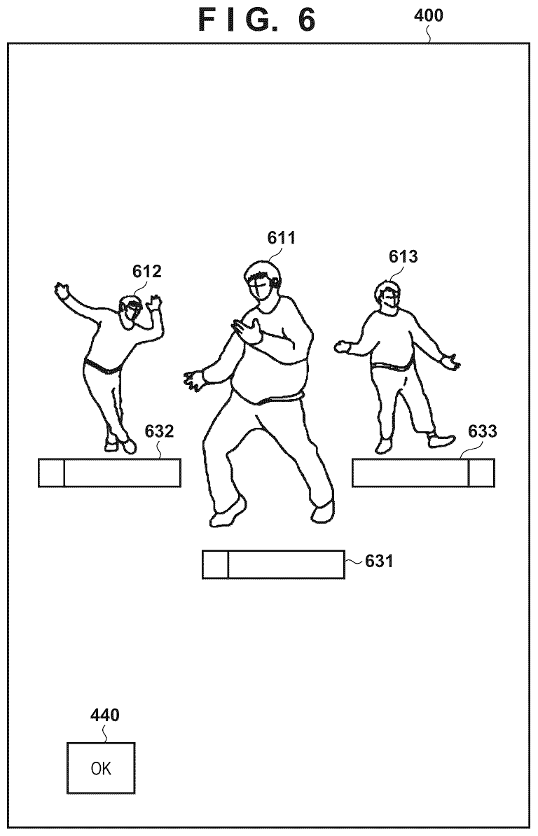

FIG. 6 illustrates an example of the screen 400 providing a user interface to be displayed in such an embodiment. On the screen 400, objects 611 to 613 are displayed. On the screen 400, timebars 631 to 633 designating the timecodes of the objects 611 to 613 are displayed in association with the objects 611 to 613. In this example, the timebars 631 to 633 are respectively displayed immediately below the objects 611 to 613. The user can independently designate the timecodes of the objects 611 to 613 of the display target by, respectively operating the timebars 631 to 633.

Furthermore, the acceptance unit 120 may accept a user operation changing the display mode of the object independently for the plurality of objects. For example, the acceptance unit 120 may accept a user operation to designate at least one of the position of the object, the orientation of the object, and the size of the object. As a specific example, the user can perform a flick operation or a rotation operation on the object 612 in order to rotate only the object 612. The user can perform a drag operation (or a drag operation after long pressing) from the object 613 in order to translate only the object 613.

In this case, the recording unit 170 can generate and record a virtual image including the images of the plurality of objects in accordance with respectively independently designated timecodes and/or respectively independently changed display modes.

In the above-described embodiment, the synthesizing unit 180 synthesizes a virtual image that is a still image and a captured image that is a still image. However, at least one of the virtual image and the captured image may be a moving image. For example, the synthesizing unit 180 may synthesize an identical virtual image with each frame of a moving image captured by the capturing unit 18. The user may designate a shooting period of a moving image that is a target of synthesis. For example, the user can designate the start point of the shooting period by an operation of pressing the button 460 and designate the end point of the shooting period by an operation of pressing the button 460 again. In this case, the synthesizing unit 180 can generate a plurality of synthesized images by synthesizing the virtual image with each captured image obtained by the capturing unit 18 repeatedly performing capturing within the shooting period. Then, the synthesizing unit 180 can record a moving image including the plurality of synthesized images.

The synthesizing unit 180 may generate a synthesized moving image of the moving image recorded by the recording unit 170 and the captured image. In this case, the acceptance unit 120 can accept a user operation to designate the timecode range. Then, the generation unit 220 can generate an image of the object corresponding to each timecode included in the timecode range in accordance with the user operation based on the 3D model data of the object corresponding to each timecode. That is, the generation unit 220 can generate a moving image of the object based on the 3D model of the object corresponding to the timecode range in accordance with the user operation. The recording unit 170 can record a moving image including a plurality of virtual images respectively corresponding to the plurality of timecodes. Here, the plurality of virtual images respectively include images of the object corresponding to each timecode. That is, the recording unit 170 can record the moving image of the object based on the 3D model of the object corresponding to the timecode range in accordance with the user operation. Note that the display control unit 160 may cause the display 17 to sequentially display the image of the object corresponding to each timecode generated by the generation unit 220. The user can designate the timecode range while viewing the image of the object displayed on the display 17.

Then, the synthesizing unit 180 can generate a synthesized moving image of the moving image recorded by the recording unit 170 and the captured moving image. For example, the synthesizing unit 180 may synthesize, for each frame, a frame of the moving image captured by the capturing unit 18 and a virtual image corresponding to each of the plurality of timecodes. The display control unit 160 can display, on the display 17, the synthesized moving image generated by the synthesizing unit 180.

Note that when the generation unit 220 generates a moving image of the object, the viewpoint may change for each timecode. In this case, the acceptance unit 120 can accept a user operation to designate the movement of the viewpoint with respect to the object. The information indicating the viewpoint changing with time in this manner is called a camera path. In one embodiment, the user can designate such a camera path by changing the physical position and attitude of the terminal 10. For example, the viewpoint with respect to the object in each timecode may follow the position and attitude of the terminal 10 at each time. Then, the generation unit 220 can generate a moving image of the object from a viewpoint moving in accordance with the user operation. The recording unit 170 can record such a moving image. According to such an embodiment, the user can designate the camera path by an intuitive operation.

The designation method of the timecode is not limited to the above example. For example, a moving image of the object may be played back on the screen 400. That is, the display control unit 160 may cause the display 17 to sequentially display the image of the object corresponding to each timecode generated by the generation unit 220. Then, when an image of a desired object is displayed, the user can perform an operation to stop the playback of the moving image. This operation corresponds to an operation by which the user designates a desired timecode.

A generation method of the synthesized image by the synthesizing unit 180 is not particularly limited. In the above-described embodiment, the synthesizing unit 180 superimposes, on a captured image, a virtual image having a transmissive region. On the other hand, a depth value may be set to each pixel of the virtual image. The generation unit 220 can set such a depth value based on the distance between the viewpoint and the 3D model. The depth value may be set to each pixel of the captured image. The depth value of each pixel of the captured image may be, for example, a constant predetermined value, or may be determined in accordance with the distance to the subject. In this case, the synthesizing unit 180 may synthesize the captured image and the virtual image based on the depth value of each pixel. In this case, for each pixel, an image having a smaller depth value can be superimposed on the other image. The generation unit 220 may synthesize a captured image and a virtual image using a technology such as alpha blending.

Furthermore, the synthesizing unit 180 may separate a captured image into a foreground and a background by using a machine learning technology, a background differencing technique, or the like. Then, the synthesizing unit 180 may synthesize the captured image and the image of the object so as to superimpose the virtual image on the background of the captured image and superimpose the foreground of the captured image on the virtual image.

The display control unit 160 may display, on a user interface for changing the display mode of the object, a synthesized image of the captured image by the capturing unit 18 and the image of the object received by the reception unit 140. For example, a synthesized image of the object 410 and the captured image 420 may be displayed on a user interface for accepting a user operation such as the screen 400. Such a synthesized image can be generated by the synthesizing unit 180. In this case, the display control unit 160 can update, in real time, the synthesized image to be displayed based on real-time capturing by the capturing unit 18.

In the above-described embodiment, the detection unit 110 detects the identification information from the medium. However, in another embodiment, the 3D model data of the object respectively corresponding to the plurality of timecodes is selected in accordance with the user operation. For example, the user may be able to select desired 3D model data from among a plurality of pieces of 3D model data in the terminal 10. Also in such a configuration, the user can easily select the image of the desired object from among many variations respectively corresponding to the plurality of timecodes.

In the above-described embodiment, the server 20 generates the image of the object. However, the terminal 10 may have at least some functions of the server 20. That is, the terminal 10 may store the 3D model data or be able to access the 3D model data. The server 20 may receive identification information and transmit 3D model data corresponding to the identification information to the terminal 10. In this case, the terminal 10 can generate an image of an object similarly to the generation unit 220. Conversely, the server 20 may have at least s part of functions of the terminal 10. The information processing apparatus according to one embodiment may be implemented by a combination of the terminal 10 and the server 20.

In the above-described embodiment, the synthesizing unit 180 included in the terminal 10 generates a synthesized image. However, it is not essential for the terminal 10 to generate a synthesized image. For example, the server 20 or another information processing apparatus may generate a synthesized image using a virtual image recorded by the recording unit 170 of the terminal 10.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-152411, filed Sep. 4, 2024, which is hereby incorporated by reference herein in its entirety.

What is claimed is:

1. An information processing apparatus comprising one or more memories storing instructions and one or more processors that execute the instructions to:
detect, from a medium, identification information for identifying 3D model data representing 3D models of an object respectively corresponding to a plurality of timecodes;
accept a user operation to designate a timecode of a display target;
cause a display to display an image of the object based on a 3D model of the object corresponding to the timecode in accordance with the identification information and the user operation; and
record, in accordance with a user operation, a virtual image to be synthesized with a captured image, the virtual image including the image of the object displayed on the display.

2. The information processing apparatus according to claim 1, wherein the one or more processors execute the instructions to accept a user operation to designate at least one of a position of the object, an orientation of the object, and a size of the object.

3. The information processing apparatus according to claim 2, wherein the one or more processors execute the instructions to cause the display to display a user interface for designating at least one of the timecode, the position of the object, the orientation of the object, and the size of the object.

4. The information processing apparatus according to claim 1, wherein the one or more processors execute the instructions to
accept a user operation to designate a viewpoint with respect to the object, and
cause the display to display an image of the object from the viewpoint.

5. The information processing apparatus according to claim 4, wherein the viewpoint with respect to the object is indicated by a physical position and attitude of the information processing apparatus with respect to the medium.

6. The information processing apparatus according to claim 1, wherein the one or more processors execute the instructions to detect the identification information based on an image of the medium in a captured image.

7. The information processing apparatus according to claim 6, wherein the identification information is printed as a code on the medium.

8. The information processing apparatus according to claim 6, wherein the medium is a printed matter.

9. The information processing apparatus according to claim 6, wherein the medium is a shaped object of a character.

10. The information processing apparatus according to claim 1, wherein
the identification information identifies the 3D model data of each of a plurality of objects, and
the one or more processors execute the instructions to
accept a user operation to designate timecodes of a display target independently for the plurality of objects, respectively, and
cause the display to display images of the plurality of objects, wherein the images of the plurality of objects are based on respective 3D models of the respective objects corresponding to respective timecodes in accordance with the user operation.

11. The information processing apparatus according to claim 10, wherein the one or more processors execute the instructions to accept a user operation to designate at least one of a position of the object, an orientation of the object, and a size of the object, independently for each of the plurality of objects.

12. The information processing apparatus according to claim 1, wherein
the identification information identifies the 3D model data of each of a plurality of objects, and
the one or more processors execute the instructions to accept a user operation to designate at least one of a position of the object, an orientation of the object, and a size of the object, independently for each of the plurality of objects.

13. The information processing apparatus according to claim 1, wherein the one or more processors execute the instructions to
accept a user operation to designate a timecode range, and
record a moving image of the object based on a 3D model of the object corresponding to the timecode range in accordance with the user operation.

14. The information processing apparatus according to claim 13, wherein the one or more processors execute the instructions to
accept a user operation to designate movement of a viewpoint with respect to the object, and
record a moving image of the object from a viewpoint moving in accordance with the user operation.

15. The information processing apparatus according to claim 13, wherein the one or more processors execute the instructions to generate a synthesized moving image of the moving image having been recorded and a captured image.

16. The information processing apparatus according to claim 1, wherein the one or more processors execute the instructions to record information indicating a region of an image of the object in the virtual image.

17. The information processing apparatus according to claim 1, wherein the one or more processors execute the instructions to generate a synthesized image of the virtual image having been recorded and a captured image.

18. An information processing system comprising one or more memories storing instructions and one or more processors that execute the instructions to:
detect, from a medium, identification information for identifying 3D model data representing 3D models of an object respectively corresponding to a plurality of timecodes;
accept a user operation to designate a timecode of a display target;
generate an image of the object based on a 3D model of the object corresponding to the timecode in accordance with the identification information and the user operation;
cause a display to display the image of the object; and
record, in accordance with a user operation, a virtual image to be synthesized with a captured image, the virtual image including the image of the object displayed on the display.

19. An information processing method comprising:
detecting, from a medium, identification information for identifying 3D model data representing 3D models of an object respectively corresponding to a plurality of timecodes;
accepting a user operation to designate a timecode of a display target;
causing a display to display an image of the object based on a 3D model of the object corresponding to the timecode in accordance with the identification information and the user operation; and
recording, in accordance with a user operation, a virtual image to be synthesized with a captured image, the virtual image including the image of the object displayed on the display.

20. A non-transitory computer-readable medium storing instructions executable by a computer to perform a method comprising:
detecting, from a medium, identification information for identifying 3D model data representing 3D models of an object respectively corresponding to a plurality of timecodes;
accepting a user operation to designate a timecode of a display target;
causing a display to display an image of the object based on a 3D model of the object corresponding to the timecode in accordance with the identification information and the user operation; and
recording, in accordance with a user operation, a virtual image to be synthesized with a captured image, the virtual image including the image of the object displayed on the display.
